(19) United States
(12) Patent Application Publication
(10) Pub. No.: US 2021/0089956 A1
(43) Pub. Date: Mar. 25, 2021

(54) MACHINE LEARNING BASED DOCUMENT ANALYSIS USING CATEGORIZATION

(71) Applicant: International Business Machines Corporation, Armonk, NY (US)

(72) Inventors: Marco Barboni, Rome (IT); Francesco Maria Carteri, Rome (IT); Luisa Mosca, Rome (IT); Ivonne Elizabeth Vereau Tolino, Rome (IT); Antonio Perrone, Rome (IT)

(21) Appl. No.: 16/576,154

(22) Filed: Sep. 19, 2019

(51) Int. Cl. G06N 20/00; G06N 5/04; G06F 16/93

(52) U.S. Cl. CPC G06N 20/00; G06F 16/93; G06N 5/04

(57) ABSTRACT

Embodiments of a computer-implemented method, system, and computer program product for analysis of news for veracity are presented. A computer can receive a document and classify the document. Using the results of the classifying, the computer can identify a plurality of techniques for testing veracity of documents. The computer can determine one or more of the plurality of techniques to use for testing the document. The computer can perform testing of the document using the determined one or more of the plurality of techniques. The computer can output results of the testing to a user.

### BACKGROUND

The present disclosure relates to machine learning, and more specifically, to machine learning based document analysis using categorization.

Historically, traditional sources of news, including newspapers, radio programs, and television news shows were a primary source of news and generally did not need verification for veracity of the news presented as they were regarded as trustworthy. Increasingly, sources of news are being called into question for their veracity. Additionally, many new sources of news, including social media, have limited inherent credibility.

### SUMMARY

Disclosed herein are embodiments of a method, system, and computer program product for document analysis using categorization are presented. A computer can receive a document and classify the document. Using the results of the classifying, the computer can identify a plurality of techniques for testing veracity of documents. The computer can determine one or more of the plurality of techniques to use for testing the document. The computer can perform testing of the document using the determined one or more of the plurality of techniques. The computer can output results of the testing to a user.

According to various embodiments described herein, a system may be provided comprising a processor for implementing the above-described method operations. Furthermore, various embodiments may take the form of a related computer program product, accessible from a computer-usable or computer-readable medium providing program code for use, by, or in connection, with a computer or any instruction execution system. For the purpose of this description, a computer-usable or computer-readable medium may be any apparatus that may contain a mechanism for storing, communicating, propagating or transporting the program for use, by, or in connection, with the instruction execution system, apparatus, or devices described herein.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts an example process for machine learning based document analysis using categorization, in accordance with some embodiments of the present disclosure.

FIG. 2 depicts an example sub-process for machine learning based document analysis using categorization, in accordance with some embodiments of the present disclosure.

FIG. 3 depicts a natural language processing system, in accordance with some embodiments of the present disclosure.

FIG. 4 illustrates a block diagram of a computer system, in accordance with some embodiments of the present disclosure.

FIG. 5 depicts a cloud computing environment according to some embodiments of the present disclosure.

FIG. 6 depicts abstraction model layers according to some embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to machine learning, and more particular aspects relate to machine learning based document analysis using categorization. While the present disclosure is not necessarily limited to such applications, various aspects of the disclosure may be appreciated through a discussion of various examples using this context.

As referred to herein, documents can include text-based documents, transcripts of audio or video recordings (or live performances), or other types of information which can be analyzed in accordance with the teachings presented herein. In some embodiments, documents can refer to news items, such as newspaper articles, news websites, audio news clips, or news videos. References and examples presented herein to news items and related terms, unless specifically noted otherwise, can also refer to documents more broadly.

Historically, traditional sources of news, including newspapers, radio programs, and television news shows were a primary source of news and generally did not need verification for veracity of the news presented as they were regarded as trustworthy. Increasingly, sources of news are being called into question for their veracity. Additionally, many new sources of news, including social media, have limited inherent credibility due to the ability of anyone to create and disseminate such content as opposed to journalists or other professionals. Currently, many social media networks allow users to post links to articles, blogs, or other sources of information which may be perceived to be news. In some cases, such pieces of news are accurate news, while in other cases, such pieces of news can be propaganda pieces, satire, or falsehoods presented as news. In order to ascertain the veracity of a document, such as a piece of news, a person can employ a variety of techniques for checking documents. Depending on the type of document or content contained within, some techniques will have greater accuracy in determining whether the news is veritable or if it is false.

Disclosed herein is a computerized process for machine learning based document analysis using categorization. The computer can receive a document and classify the document into a variety of categories. Based on the classification into categories, the computer can identify potential techniques to use in testing veracity of the document. The computer can determine which of these techniques to use for testing veracity of the document based on reliability scores for documents in the identified classifications for the document. The computer can use these determined techniques to test the veracity of the document by performing a deep analysis. The computer can receive feedback from the user regarding the veracity of the document and accuracy of the computer's determination and update the methodology based on the feedback received.

A system and process for machine learning based document analysis using categorization as described herein can provide advantages over prior ways of checking a news item for veracity. As disclosed herein, a plurality of techniques for checking a news item can be identified, and one or more of these techniques best suited for determining the veracity of a news item classified as the news item is classified can be used. As such, not all techniques for determining veracity need to be used, a person does not need to manually perform testing of the news item, and time and resources can be saved by determining and using the best techniques appropriate to a given news item. Over time, the system and process can be improved by utilizing user feedback based on the veracity of the news items to continually improve and provide better results. These improvements and/or advantages are a non-exhaustive list of example advantages. Embodiments of the present disclosure exist which can contain none, some, or all of the aforementioned advantages and/or improvements.

Many techniques for testing the veracity of a news item can be used with the teachings of the present disclosure. Testing the veracity of a news item can include checking the news item itself and/or testing one or more elements within a news item, such as statements of fact, quotations, statistics, or other elements in the news item. References herein to testing or checking a news item should be read to include testing one or more elements within a news item unless expressly noted.

A first example technique is checking the source of the news item to determine if it is reliable. This can include checking a list of known sources (e.g., websites, authors, media organizations, etc.) wherein the list also includes a rating, score, or identifier such as truthful or not truthful (or reliable and unreliable, verified and unverified, etc.). The more often this technique is used, the larger the list of known sources can become and the greater accuracy the rating, score, or identifier can be.

A second example technique is performing an internet search for the news item, including on one or more search engines to determine whether the news item is reported on reliable websites. This second example technique can use a list such as that of the first example technique in determining which websites are reliable, such that if the internet search yields the news item reported on such websites, this can be an indicator that the news item is truthful. A lack of the news item appearing on reliable websites or on a small number of such websites can indicate the news item lacks veracity and may be unreliable. In some embodiments, a threshold number of reliable websites reporting the news item can be used. In some other embodiments, a veracity score can be computed based on the number of reliable websites reporting the news item.

A third example technique is searching for the news item on one or more fact-checking websites or other sources. Various websites exist and are dedicated to checking statements of fact, quotes, urban myths, or other claims which have been called into question. Checking a news item or elements of a news item against one or more of such fact checking sources can identify a news item as truthful, reliable, or unverified.

A fourth example technique is checking whether the same news item has been reported by multiple different providers, and if so checking if the reported source is always the same. For example, if a news item is reposted by many users, checking to see if the news item is attributed to different sources, authors, or is otherwise being distorted in one or more representations can provide information relating to the reliability of the news item. Furthermore, the source or sources the news item is being attributed to can be checked to determine their reliability, which may be done in a similar fashion as the first example technique.

A fifth example technique can be used in situations where the news item is a website or includes reference to one or more websites. This technique can be checking the domain name of the website(s) to determine whether it is an official domain name or a fraudulent domain name. For example, many domain names exist where a misspelling or other alteration of an official website directs to a different website or to no website at all. For example, the following three domain names may not direct to an official website of an example newspaper: www.examplenewspaper-real-news.com, www. examplneewspaper.co, and www. examplenewspapier.com if the real website is www.examplenewspaper.com, due to the alterations and misspellings.

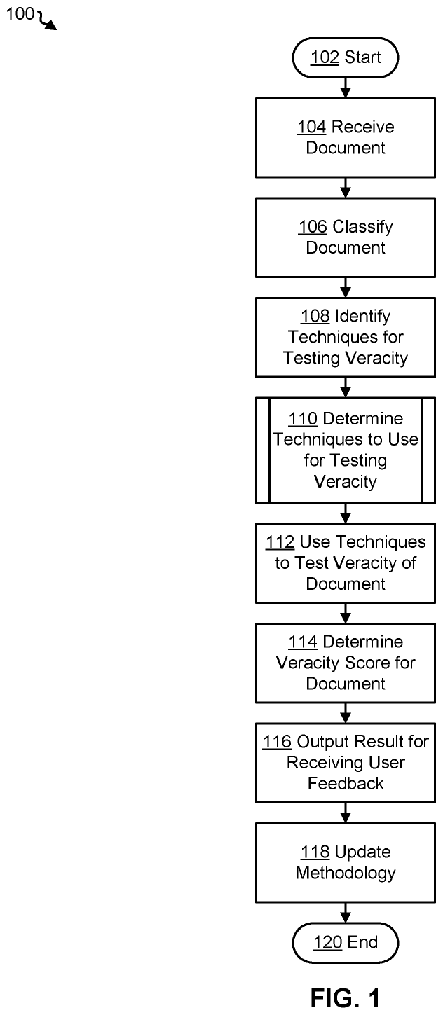

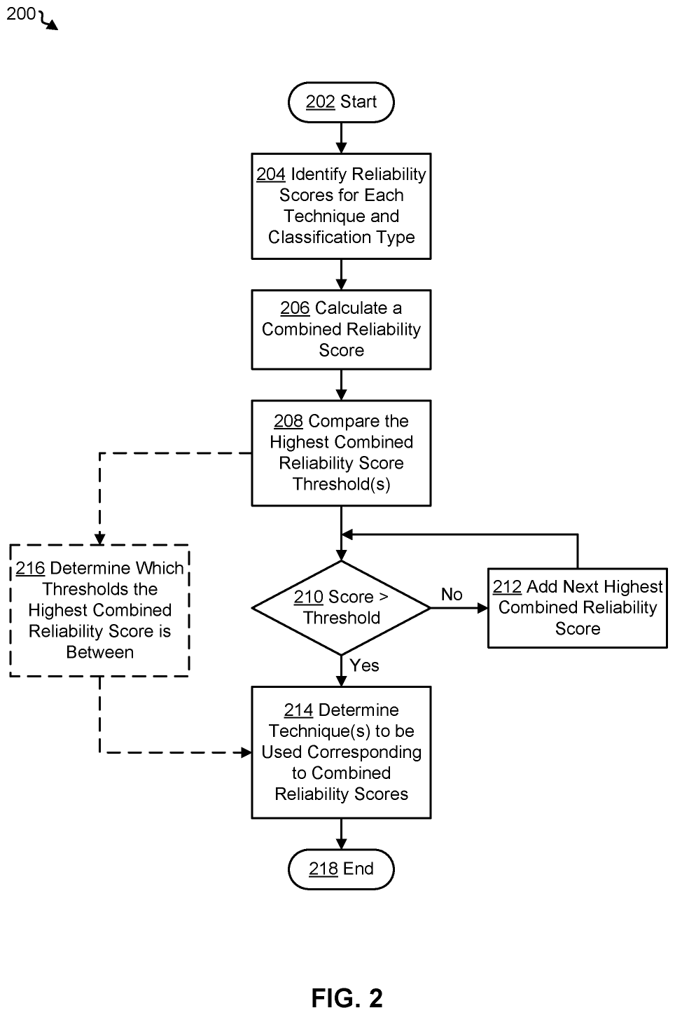

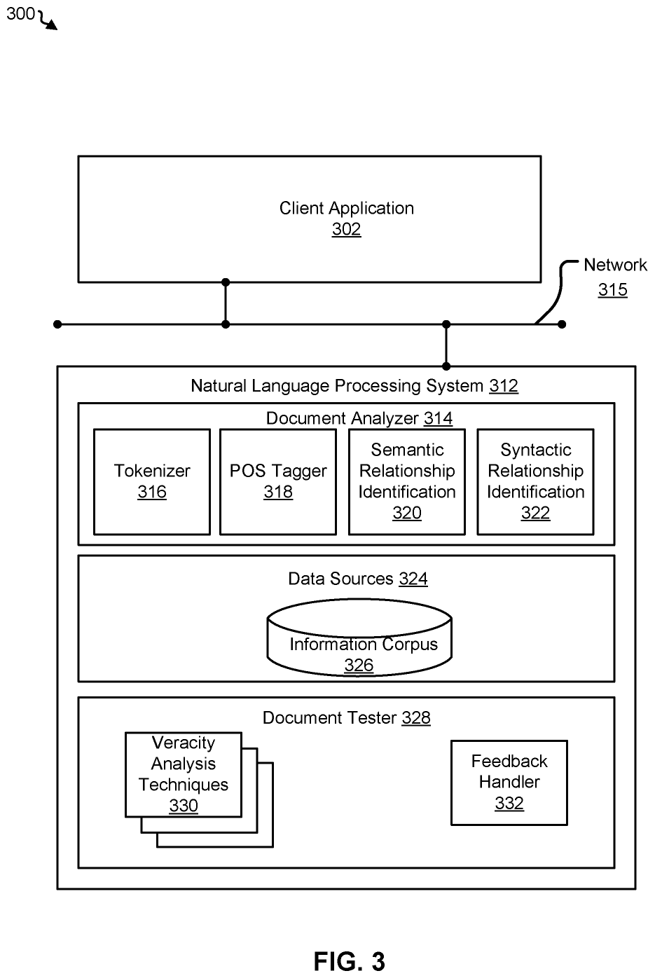

A sixth example technique is checking whether the subject matter of the news item is something on which humans are generally fascinated (e.g., potential natural disaster, illness, diseases, and pollution) or something highly improbable (e.g., a child casually discovering a cure for cancer). This could be performed by analyzing the text of the news item, such as by natural language processing as discussed below in regard to FIG. 3, to determine keywords or tokens and comparing those to a list of known topics or subject matter. In some embodiments, this sixth example technique could be used as a preliminary test to determine the depth of veracity testing required. For example, if the subject matter of the news item is something on which humans are generally fascinated, additional testing could be performed because there may be many inaccurate results which could affect determining veracity. Similarly, if the subject matter regards something highly improbable, only limited testing may be needed to determine if it is unverifiable. Such preliminary testing could be used in some embodiments to set one or more thresholds used in process 100 and/or sub-process 200 of FIGS. 1-2.

A seventh example technique is determining whether the source, author, publisher, or other person involved in creating or distributing the news item has a particular point of view which may influence the veracity of the news item. This may be performed by checking an “About Us” section of a news source for more insight into such persons, leadership entities involved, and/or mission statements. This technique may also be used to determine if the news item was created by a satire source, such as a satirical news website. In some embodiments, this can involve checking whether a person involved in creating or distributing the news item has a known political bias. Indications of strong viewpoints or bias can lower a veracity score associated with the news item, even if the news item is not determined to be unreliable or unverified.

An eighth example technique is checking if a news item meets one or more academic citation standards, such as the APA (American Psychological Association) citation style, the MLA (Modern Language Association) citation style, or the Chicago citation style. If a news item is appropriately sourced and/or cited, this can be an indication that the news item is more likely to be truthful, whereas a poorly or inaccurately sourced and cited news item can be more likely to be unreliable.

A ninth example technique is performing a quality check of the news item. This can include checking whether there are (and if so, how many) spelling errors, grammatical errors, usage of phrases in all-caps, use of dramatic punctuation (e.g., “?!?!?!?”), missing punctuation, overuse of abbreviations, including abbreviations common to texting and internet comments (e.g., “OMG,” “YOLO,” “LMAO,” “IMHO,” “2day”), or other indications of poor quality writing. Because reputable sources generally have high proofreading and grammatical standards, errors, colloquialisms, and/or low-quality writing may be indicative of an unreliable source. In some embodiments, this may involve creating a quality score for the news item. This quality score can then be related to a veracity score and/or compared to one or more threshold values in determining the veracity of the news item.

A tenth example technique is checking whether the news item or an element of the news item, such as a picture included with a news article, is current or has been previously used. If a news story has been previously published or if an image created for one news source is being taken out of context and used with a new news item, this can be indicative of an unreliable story. In some embodiments, exceptions may be made for seasonal news items (e.g., a website may re-publish a story or similar story about the origins of Valentine's Day every February or recycle news pieces relating to a national holiday). Recycled news stories due to the time of the year may not have the same indications of falsehood as other reuses of news items.

An eleventh example technique is checking the identity of one or more persons quoted in a news item and the content of their quotations. If the person(s) quoted are known for a lack of truthfulness or satire, this can be indicative that the news item is not a real or accurate news item. If the quotations are misquotations or misattribution of quotations, this can also be indicative of an unreliable news item. Additionally, a lack of quotations and/or contributing sources, particularly on a complex issue, can indicate low reliability. On the other hand, inclusion of accurate quotations, by reliable sources, can provide increased confidence that the news item is genuine because credible journalism is generally fed by fact-gathering, whereas a lack of research can mean a lack of fact-based information.

A twelfth example technique is performing reverse searches for sources citing the news item in question and checking sources cited by the news item in question. If one or more sources cite the news item, statements made by that citing source can indicate whether the news item is true or unreliable. Additionally, for either a cited or citing source, one or more of the techniques presented herein or other techniques, can be performed to determine their veracity. If a cited source, or source which cites the news item is a credible source, that can lend credibility to the news item, and the reverse is also true. The content of any cited sources can also be checked to see if the news item accurately quoted or discussed what was present in the cited source or if it has been altered.

A thirteenth example technique is performing a reverse image search on any images associated with the news item. By searching a database and/or the internet using such an image, other news items, websites, or documents which use the image or a similar image can be retrieved and compared to the news item in question. This information can be used to determine if the image has been taken out of context, altered, sourced from a disreputable source of information, or otherwise provide information regarding the veracity of the news item.

A fourteenth example technique is performing an internet search for the title or main idea of the news item with a word or phrase designed to test its veracity such as “unfounded,” “fact check,” “real or fake,” etc. If one or more websites or other sources can be found which either confirm or cast doubt on the veracity of the news item, this information can be used to affect a veracity score of the news item.

A fifteenth example technique is checking the style of the writing of the news item. Many journalistic sources use a system called the “Five Ws” and present information on the where, when, who, what, and why of a news story. In some cases, an H or 6^{th} W is added for “how.” A news item written in this style or other style identified as associated with verifiable news items (or identified with unreliable news items) can provide information relating to the veracity of the news item in question.

The example techniques for testing the veracity of a news item presented herein are for example purposes only. Many other techniques for testing the veracity of a news item can be envisioned and used without deviating from the scope of the present disclosure. Furthermore, many modifications to the provided examples can be made in accordance with the present disclosure.

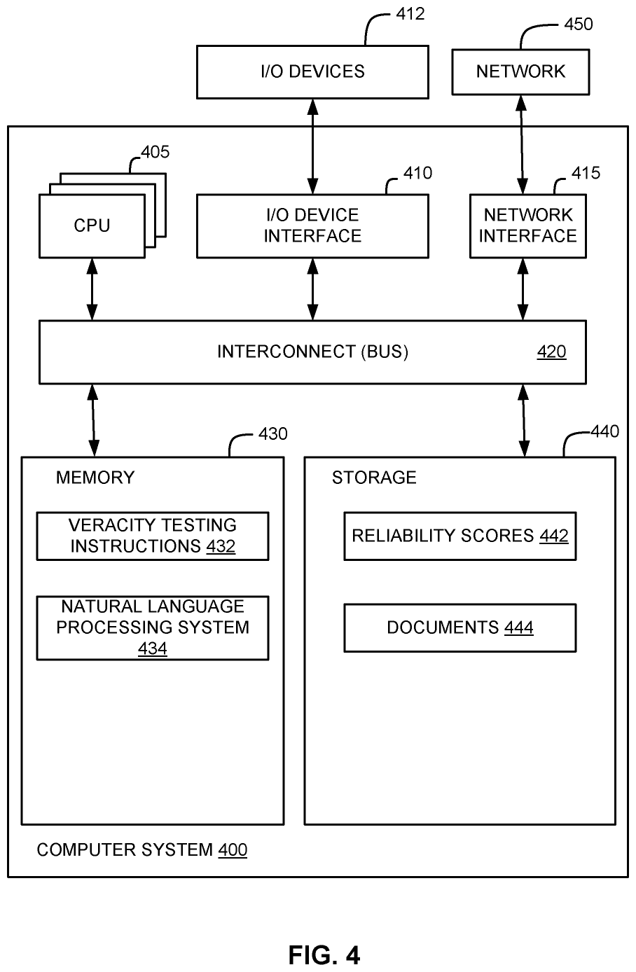

FIG. 1 depicts an example process 100 for machine learning based document analysis using categorization, in accordance with embodiments of the present disclosure. Process 100 can include more or fewer operations than those depicted. Process 100 can include operations in different orders than those depicted. In some embodiments, process 100 can be performed by or performed using a natural language processing environment (such as natural language processing environment 300 depicted in FIG. 3) and/or by a computer system (such as computer system 400 depicted in FIG. 4).

From start 102, process 100 proceeds to 104 wherein the computer receives a document. In some embodiments, the document can be a news item and the news item can be received when a user submits a news item, such as to test a news item for veracity. In some embodiments, a computer can receive one or more documents automatically. This may occur when a social media website, forum, or other aggregator of potential news items receives a post by a user and the aggregator of potential news items has configured a computer, computers, or cloud-based network of computing resources to automatically check all news items received, or some subset for testing. In some embodiments, a document can be an entire article, post, website, etc., while in other embodiments, a document can be a quotation, statement of fact, or other element of a document to be tested for veracity.

At operation 106, the document received at 104 is classified into one or more categories. The classifications and any methods for performing the classification can vary in embodiments. In some embodiments the received document can be classified by source of the document, content within the document, author of the document, type of document, or other classifications. One or more of these classifications can be the result of natural language processing on the document, which can include identification of keywords or tokens related to classifications, part of speech tagging, semantic relationship identification, and/or syntactic relationship identification. In some embodiments, the classification can be performed using one or more techniques for classifying data.

At operation 108, the computer identifies techniques for testing veracity of the document. The techniques for testing veracity of the document can include the fifteen example techniques presented above and/or other techniques for testing veracity. Identification of the techniques for testing veracity can include identifying techniques which are possible for the received document (e.g., excluding techniques involving image searching when no images are present in the document, excluding techniques based on citations when there are no citations unless the lack of citations is used by the technique, including techniques based on one or more aspects of the document, etc.). In some embodiments, one or more techniques can be identified which require assistance of a human operator to perform the technique. Identification of techniques for testing veracity of the document can only identify such techniques when a human operator is present and omit such techniques if one is not. In some embodiments, all techniques may be computer-implemented techniques.

At operation 110, the computer determines techniques to use for testing veracity of the document from the techniques identified at operation 108. This determination can be based upon the classification performed at operation 106. Additional detail regarding operation 110 is described below with regard to FIG. 2. Determination of the techniques to use for testing veracity of the document can involve determining which techniques are most appropriate for the received document from among the identified techniques. This can include performing techniques which are faster to perform, require fewer computing resources, provide the most accurate results, or otherwise meet criteria used for determining which techniques to perform. In some embodiments, a user may input a number of techniques to perform, a requested time frame in which the techniques are to be performed, or an allotted amount of computing resources to use for testing the veracity of a document, and the determining can be based on such input. In some embodiments, each technique can have a reliability score assigned to it or a reliability score for each identified content type, and the determination of which techniques will be performed can be based on the reliability scores of the techniques.

At operation 112, the computer uses the determined techniques for testing veracity of the document. Using the determined techniques for testing veracity can be performed by following a set of procedures created for each testing technique. This will vary in embodiments depending on the determined techniques and the document to be tested. Depending on the techniques used, one or more threshold values may be used for comparing the document, such as the threshold number of reliable websites reporting a news item for the second example technique. These can be user-set variables or variables determined through machine learning. Such variables can be updated in operation 118 below based upon user feedback to improve the techniques for future performances of process 100.

At operation 114, the computer determines a veracity score for the document. Each technique used for testing veracity of the document at operation 112 can provide an output value which can be used in determining a veracity score. In some embodiments, the output of each technique can be a binary determination such as truth/false, verified/unverified, etc., and these outputs can be assigned to a 1 or 0. An average of the outputs from the techniques, or the most common result, can be the determined veracity score at operation 114. In some embodiments, the output of each technique can be a technique-specific veracity score and an average of these scores can be taken an operation 114 to generate an overall veracity score. In some embodiments, some techniques used can output a binary determination, while other techniques output a veracity score, and these outputs can be normalized and combined in some fashion. For example, if the output of the ninth example technique (performing a quality check of the writing of the news item) is a veracity score based on how many spelling, grammatical, or other errors are involved, it can be converted into a decimal number, e.g., a ratio of correctly spelled words, which can be averaged with one or more 0 or 1 outputs from binary determinations to reach an overall veracity score. In some embodiments, one or more of the testing techniques may be weighted to be more or less important in the veracity score. This may occur if a veracity testing technique has been identified to be more accurate and may be based on user feedback, such as that received at operation 116.

At operation 116, the computer outputs the result for receiving user feedback on the veracity score determined by the computer. The veracity score and/or any technique-specific veracity scores can be presented to a user, including with a determination of true/false, verified/unverified, or other such designation. A user can provide feedback to the computer based upon their knowledge, independent research, or otherwise, indicating whether the result is correct or not. In some embodiments, this step can be optional, and a user may not be required to provide feedback. In some embodiments, this step can be used when providing training data to a machine learning algorithm, such that known reliable or known unreliable documents can be provided to the computer, tested by the computer, and the testing improved by identifying which results are accurate and which are not. This provision of training data can occur during a learning phase before process 100 is performed using user submitted content. During such a learning phase, each technique can be performed (e.g., the determining at operation 110 can determine to use all techniques) for a sample of a number N of unreliable documents and a number M of reliable documents. Reliability scores for each technique can be increased by 1/(N+M) when either a reliable or unreliable document is correctly identified.

At operation 118, the methodology used by the computer is updated. In some embodiments, the updating can be based on the feedback received at operation 116. Updating the methodology can vary in embodiments and can vary based on the type of feedback received. If a user reports that a document has been accurately identified as reliable or not, weights or scores assigned to the techniques for testing veracity which corresponded to such designation can be increased, while techniques which yielded the opposite result can have weights or scores decreased. In some embodiments, techniques which result in outputs which vary from other performed techniques may have weights or scores decreased (e.g., if five techniques were used and four indicated the document was reliable, but the fifth indicated it was unreliable, the fifth technique could be identified as an outlier and have its weight or score decreased for future performances of process 100). In some embodiments, the methodology can be updated by flagging sources, authors, or other aspects of a document as having generated either reliable or unreliable results. This information can be used in performing techniques for testing veracity in the future. In some embodiments, upon reaching a threshold number of positive or negative results, a source, author, or other aspect of a document can be added to a whitelist or blacklist so as to indicate that it is associated with reliability or a lack of reliability. In some embodiments, this can become a factor in determining the veracity score at 114. After operation 118, process 100 ends at 120.

FIG. 2 depicts an example sub-process 200 for machine learning based document analysis using categorization, in accordance with embodiments of the present disclosure. Sub-process 200 can include more or fewer operations than those depicted. Sub-process 200 can include operations in different orders than those depicted. In some embodiments, sub-process 200 can be performed by or performed using a natural language processing environment (such as natural language processing environment 300 depicted in FIG. 3) and/or by a computer system (such as computer system 400 depicted in FIG. 4). In some embodiments, sub-process 200 can be a detailed version of operation 110 of process 100 of FIG. 1.

Sub-process 200 may reach start 202 during performance of process 100 above. Sub-process 200 can be a detailed version of operation 110 of FIG. 1 for determining techniques to use for testing veracity of the document from an identified list of techniques. After start 202, sub-process 200 proceeds to 204 to identify reliability scores for each of the identified techniques and each classification type of a document being tested for veracity.

Each technique for testing veracity can have a reliability score for each type of content (or in some embodiments one overall reliability score regardless of content type). Examples of types of content can be wonder, sensationalism, weather, medicine, science, sports, etc. In some embodiments, each technique can have reliability scores for authors, types of authors, websites where the document was posted, or for other types of classifications, such as classifications generated at operation 106 of process 100. The reliability scores can be generated by utilizing machine learning techniques and be adjusted with each successful or failed identification of a document as verified or unverifiable. The reliability scores can also be updated with some or all performances of method 100 based upon user input or other determinations that a technique resulted in an accurate or failed identification of the document's veracity. These reliability scores can be stored in a table, list, or other repository, and the identification of these scores at operation 204 can comprise retrieving the appropriate scores for the corresponding techniques and/or classification types for a document being analyzed for veracity in process 100.

At operation 206, the computer calculates a combined reliability score for each technique. A technique may have multiple different reliability scores for each of the classifications for a document being analyzed. For example, a technique may have a first reliability score for analyzing social media posts, a second reliability score for analyzing pictures, and a third reliability score for analyzing documents relating to sporting events. A combined reliability score can be calculated for each technique based on its one or more reliability scores. In some embodiments, this calculation can be taking an average of the various reliability scores. In some embodiments, this calculation can be taking the highest, lowest, median, or mode of these reliability scores.

At operation 208, the computer compares the highest of the calculated combined reliability scores to a threshold value or values. One or more threshold values can be used in determining how many techniques for testing veracity are used in performance of method 100, e.g., at operation 112. In some embodiments, one threshold value is used and sub-process 200 proceeds to operation 210. In some embodiments, multiple threshold values are used and sub-process 200 proceeds to operation 216. This alternative is presented in dashed lines and in any given performance of sub-process 200, only one of either operations 210-212 or operation 216 will be used.

At operation 210, the computer determines whether the score is greater than the threshold. In some embodiments, the computer can determine whether the score is greater than or equal to the threshold. If the highest combined reliability threshold is greater than the threshold (or if one or more next highest combined reliability scores have been added at 212 and operation 210 is being returned to), sub-process 200 continues to operation 214.

If the score is not greater than (or in some embodiments, not greater than or equal to) the threshold, sub-process 200 proceeds to operation 212, where the next highest combined reliability score is identified and added to the score. The first time operation 212 is reached, this next highest combined reliability score is added to the highest combined reliability score. If operation 212 is reached on subsequent occasions within performance of sub-process 200, this next highest combined reliability score is added to a running sum of the highest combined reliability score and next highest scores added previously.

Once at operation 210 it is determined that the score (which may be a sum of scores if 212 has been reached at least once) is greater than (or greater than or equal to) the threshold, sub-process 200 proceeds to operation 214. By looping through operations 210-212 until the sum of combined reliability scores exceeds the threshold, the number of techniques to be used in testing the veracity of a document is determined. For example, a threshold value may be 0.8 and a first technique may have a combined reliability score of 0.7 and a second technique may have combined reliability score of 0.6. The first time operation 210 is reached, the result will be “no,” and at operation 212 the 0.6 is added to the 0.7. When sub-process 200 returns to operation 210, the score will now be 1.3, which exceeds the threshold of 0.8 and sub-process 200 proceeds to operation 214.

At operation 214, the computer determines the techniques to be used corresponding to the combined reliability scores. If operation 214 is reached from operation 210, the techniques to be used are those corresponding to each of the combined reliability scores used to exceed the threshold (i.e., the highest combined reliability score and any next highest combined reliability scores added). Continuing with the above example, it can be determined that the first and second techniques will be used. The lower the values of a plurality of the highest combined reliability scores, the higher the number of testing techniques may be required to exceed the threshold, and thus be used.

At operation 216, the computer determines which thresholds the highest combined reliability score is between. For example, there can be a first threshold value of 1.0 and a second threshold value of 0.9. If the highest of the calculated combined reliability scores is above 0.9, this can be used in operation 214 to determine that only one technique is needed to be used because there is sufficient reliability in that technique alone. Continuing with this example, if the highest reliability score is not between these thresholds, additional techniques for testing veracity may be determined to be needed. For example, a third threshold value can be 0.8 and if the highest combined reliability score is between 0.8 and 0.9, it can be determined at operation 214 to use two testing techniques (e.g., the two techniques with the highest combined reliability scores). A plurality of thresholds can be used, with a different number of techniques to be used if the highest combined reliability score is between pairs of these thresholds. These thresholds may instead be presented as ranges, and the highest reliability score can be determined to be within a range (including one or both endpoints of the range). The lower the values of the single highest combined reliability score, the higher the number of testing techniques may be used.

After operation 214, sub-process 200 ends at 218.

FIG. 3 depicts a natural language processing environment 300, in accordance with embodiments of the present disclosure. Aspects of FIG. 3 are directed toward an exemplary natural language processing environment 300 in performance of process 100, particularly with regard to operation 106 involving classifying documents and/or operation 112 involving using techniques to test veracity of documents. Natural language processing environment 300 can be remote from the computer performing process 100 and/or sub-process 200 and connected e.g., by cloud technology. In other embodiments, natural language processing environment 300 can be a part of or otherwise connected to a computer system, such as computer system 400 of FIG. 4. Natural language processing system 312 can perform methods and techniques for responding to the requests sent by one or more client application 302. In certain embodiments, the information received at natural language processing system 312 may correspond to input documents received from users or websites, where the input documents may be expressed in a free form and in natural language.

In certain embodiments, client application 302 and natural language processing system 312 can be communicatively coupled through network 315 (e.g., the Internet, intranet, or other public or private computer network). In certain embodiments, natural language processing system 312 and client application 302 may communicate by using Hypertext Transfer Protocol (HTTP) or Representational State Transfer (REST) calls. In certain embodiments, natural language processing system 312 may reside on a server node. Client application 302 may establish server-client communication with natural language processing system 312 or vice versa. In certain embodiments, the network 315 can be implemented within a cloud computing environment or using one or more cloud computing services. Consistent with various embodiments, a cloud computing environment can include a network-based, distributed data processing system that provides one or more cloud computing services.

Consistent with various embodiments, natural language processing system 312 may respond to information sent by client application 302 (e.g., documents provided by users). Natural language processing system 312 can analyze the received documents. In certain embodiments, natural language processing system 312 may include a document analyzer 314, data sources 324, and document tester 328. Document analyzer 314 can be a computer module that analyzes the received documents. In certain embodiments, document analyzer 314 can perform various methods and techniques for analyzing the documents syntactically and semantically. In certain embodiments, document analyzer 314 can parse received documents. Document analyzer 314 may include various modules to perform analyses of received documents. For example, computer modules that document analyzer 314 may encompass include, but are not limited to, a tokenizer 316, part-of-speech (POS) tagger 318, semantic relationship identification 320, and syntactic relationship identification 322. In certain embodiments, the document analyzer 314 can include using a natural language processing technique.

Consistent with various embodiments, tokenizer 316 may be a computer module that performs lexical analysis. Tokenizer 316 can convert a sequence of characters into a sequence of tokens. Tokens may be string of characters typed by a user and categorized as a meaningful symbol. Further, in certain embodiments, tokenizer 316 can identify word boundaries in an input document and break the document or any text into its component parts such as words, multiword tokens, numbers, and punctuation marks. In certain embodiments, tokenizer 316 can receive a string of characters, identify the lexemes in the string, and categorize them into tokens.

Consistent with various embodiments, POS tagger 318 can be a computer module that marks up a word in a text to correspond to a particular part of speech. POS tagger 318 can read a document or other text in natural language and assign a part of speech to each word or other token. POS tagger 318 can determine the part of speech to which a word corresponds based on the definition of the word and the context of the word. The context of a word may be based on its relationship with adjacent and related words in a phrase, sentence, question, or paragraph. In certain embodiments, context of a word may be dependent on one or more previously provided documents. Examples of parts of speech that may be assigned to words include, but are not limited to, nouns, verbs, adjectives, adverbs, and the like. Examples of other part of speech categories that POS tagger 318 may assign include, but are not limited to, comparative or superlative adverbs, wh-adverbs (e.g., when, where, why, whence, whereby, wherein, whereupon), conjunctions, determiners, negative particles, possessive markers, prepositions, wh-pronouns (e.g., who, whom, what, which, whose), and the like. In certain embodiments, POS tagger 318 can tag or otherwise annotate tokens of a document with part of speech categories. In certain embodiments, POS tagger 318 can tag tokens or words of a document to be parsed by natural language processing system 312.

Consistent with various embodiments, semantic relationship identification 320 may be a computer module that can identify semantic relationships of recognized identifiers in documents provided by users. For example, the semantic relationship identification 320 may include identifying recognized identifiers such as authors, websites, types of documents, document sources, institutions, corporations, and other entities. In certain embodiments, semantic relationship identification 320 may determine functional dependencies between entities, the dimension associated to a member, and other semantic relationships.

Consistent with various embodiments, syntactic relationship identification 322 may be a computer module that can identify syntactic relationships in a document composed of tokens provided by users to natural language processing system 312. Syntactic relationship identification 322 can determine the grammatical structure of sentences, for example, which groups of words are associated as “phrases” and which word is the subject or object of a verb. In certain embodiments, syntactic relationship identification 322 can conform to a formal grammar.

In certain embodiments, document analyzer 314 may be a computer module that can parse a received document and generates a corresponding data structure of the document. For example, in response to receiving a document at natural language processing system 312, document analyzer 314 can output the parsed document as a data structure. In certain embodiments, the parsed document may be represented in the form of a parse tree or other graph structure. To generate the parsed document, document analyzer 314 may trigger computer modules 316-322. Document analyzer 314 can use functionality provided by computer modules 316-322 individually or in combination. Additionally, in certain embodiments, document analyzer 314 may use external computer systems for dedicated tasks that are part of the document parsing process.

Consistent with various embodiments, the output of document analyzer 314 can be used by natural language processing system 312 to perform a search of one or more data sources 324 to identify classifications for the document. In certain embodiments, data sources 324 may include data warehouses, information corpora, data models, and document repositories. In certain embodiments, the data source 324 can be an information corpus 326. The information corpus 326 can enable data storage and retrieval. In certain embodiments, the information corpus 326 may be a storage mechanism that houses a standardized, consistent, clean and integrated form of data. The data may be sourced from various operational systems. Data stored in the information corpus 326 may be structured in a way to specifically address reporting and analytic requirements. In one embodiment, the information corpus may be a relational database. In some example embodiments, data sources 324 may include one or more document repositories.

In certain embodiments, document tester 328 may be a computer module that classifies documents into one or more classifications and/or performs other analyses of documents. Consistent with various embodiments, document tester 328 may include a plurality of veracity analysis technique modules 330 and a feedback handler 332.

Veracity analysis technique modules 330 can be computer modules for performing or assisting with the performance of various techniques for analyzing the veracity of a document. This can include the fifteen example techniques discussed above. In some embodiments, natural language processing may be used to perform some or all of these techniques, while in other embodiments, some or all of these techniques may utilize these modules to assist with performance of the technique. For example, NLP may be used in the ninth example technique when checking for spelling, grammar, or other errors or in performing the fifteenth example technique involving checking the writing style in for the 5 W's.

In certain embodiments, feedback handler 332 can be a computer module that processes feedback from users on the output of the analysis of the documents. In certain embodiments, users may be engaged in dialog with the natural language processing system 312 to evaluate the accuracy of the veracity score(s) received. In certain embodiments, the feedback of users on these lists may be used for future natural language processing sessions.

The various components of the exemplary natural language processing system described above may be used to implement various aspects of the present disclosure. For example, the client application 302 could be used to receive one or more documents. The document analyzer 314 could, in certain embodiments, use a natural language processing technique to analyze the document, and identify keywords and word relationships in the document. Further, the natural language processing system 312 could, in certain embodiments, compare the keywords to an information corpus 326 to determine keywords which correspond to classifications for documents. The document tester 328 can be used to classify and or analyze the veracity of documents based on the documents input to the natural language processing system 312.

Referring now to FIG. 4, illustrated is a block diagram of a computer system 400, in accordance with some embodiments of the present disclosure. In some embodiments, computer system 400 performs operations in accordance with FIGS. 1 and 2 as described above. The computer system 400 can include one or more processors 405 (also referred to herein as CPUs 405), an I/O device interface 410 which can be coupled to one or more I/O devices 412, a network interface 415, an interconnect (e.g., BUS) 420, a memory 430, and a storage 440.

In some embodiments, each CPU 405 can retrieve and execute programming instructions stored in the memory 430 or storage 440. The interconnect 420 can be used to move data, such as programming instructions, between the CPUs 405, I/O device interface 410, network interface 415, memory 430, and storage 440. The interconnect 420 can be implemented using one or more busses. Memory 430 is generally included to be representative of a random access memory (e.g., static random access memory (SRAM), dynamic random access memory (DRAM), or Flash).

In some embodiments, the memory 430 can be in the form of modules (e.g., dual in-line memory modules). The storage 440 is generally included to be representative of a non-volatile memory, such as a hard disk drive, solid state device (SSD), removable memory cards, optical storage, or flash memory devices. In an alternative embodiment, the storage 440 can be replaced by storage area-network (SAN) devices, the cloud, or other devices connected to the computer system 400 via the I/O devices 412 or a network 450 via the network interface 415.

The CPUs 405 can be a single CPU, multiple CPUs, a single CPU having multiple processing cores, or multiple CPUs with one or more of them having multiple processing cores in various embodiments. In some embodiments, a processor 405 can be a digital signal processor (DSP). The CPUs 405 can additionally include one or more memory buffers or caches (not depicted) that provide temporary storage of instructions and data for the CPUs 405. The CPUs 405 can be comprised of one or more circuits configured to perform one or more methods consistent with embodiments of the present disclosure.

The memory 430 of computer system 400 includes veracity testing instructions 432 and natural language processing system 434. Veracity testing instructions 432 can be an application or compilation of computer instructions for analyzing one or more documents and performing veracity testing. Veracity testing instructions 432 can be computer instructions for performing process 100 and/or sub-process 200 as described above with regard to FIGS. 1 and 2.

Natural language processing system 434 can be an application or compilation of computer instructions for performing natural language processing. Natural language processing system 434 can be consistent with natural language processing system 312 of FIG. 3 and can be involved in performing operations of FIG. 1, particularly operations 106 and 112 as discussed above.

Storage 440 contains reliability scores 442 and document 444. Reliability scores 442 can be scores assigned each technique for testing veracity of a document or can be multiple scores for each technique, with one for each classification. Reliability scores 442 can be used in the determination of which techniques will be performed in analyzing a given document, such as one of documents 444. Reliability scores 442 can be generated by utilizing machine learning techniques and be adjusted with each successful or failed identification of a document as verifiable or unverified. Reliability scores 442 can be stored in a table, list, or other repository.

Documents 444 can be various types of documents received by computer system 400. Documents 444 can be received when a user submits a document, such as to test a news item for veracity. In some embodiments, documents 444 can be received automatically, such as when a social media website, forum, or other aggregator of potential news items receives a post by a user and the aggregator of potential news items has configured computer system 400 to automatically check all news items received, or some subset for testing. In some embodiments, documents 444 can be entire articles, posts, websites, etc., while in other embodiments, documents 444 can be quotations, statements of fact, or other elements of a document to be tested for veracity.

In some embodiments as discussed above, the memory 430 stores veracity testing instructions 432 and natural language processing system 434, and the storage 440 stores reliability scores 442 and documents 444. However, in various embodiments, each of the veracity testing instructions 432, natural language processing system 434, reliability scores 442, and documents 444 are stored partially in memory 430 and partially in storage 440, or they are stored entirely in memory 430 or entirely in storage 440, or they are accessed over a network 450 via the network interface 415.

In various embodiments, the I/O devices 412 can include an interface capable of presenting information and receiving input. For example, I/O devices 412 can receive input from a user and present information to a user and/or a device interacting with computer system 400. In some embodiments, I/O devices 412 can include a display and/or an audio speaker for presenting information to a user of computer system 400.

The network 450 can connect (via a physical or wireless connection) the computer system 400 with other networks, and/or one or more devices that interact with the computer system.

Logic modules throughout the computer system 400—including but not limited to the memory 430, the CPUs 405, and the I/O device interface 410—can communicate failures and changes to one or more components to a hypervisor or operating system (not depicted). The hypervisor or the operating system can allocate the various resources available in the computer system 400 and track the location of data in memory 430 and of processes assigned to various CPUs 405. In embodiments that combine or rearrange elements, aspects and capabilities of the logic modules can be combined or redistributed. These variations would be apparent to one skilled in the art.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

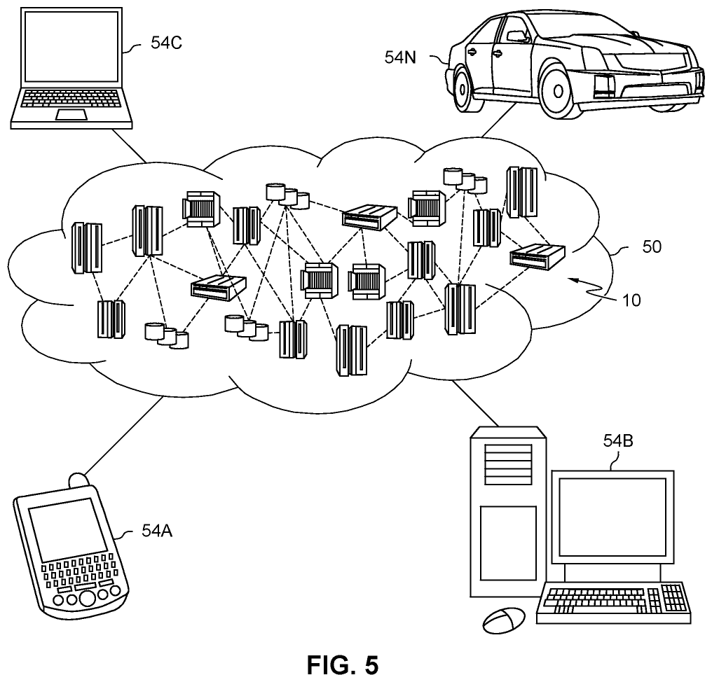

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

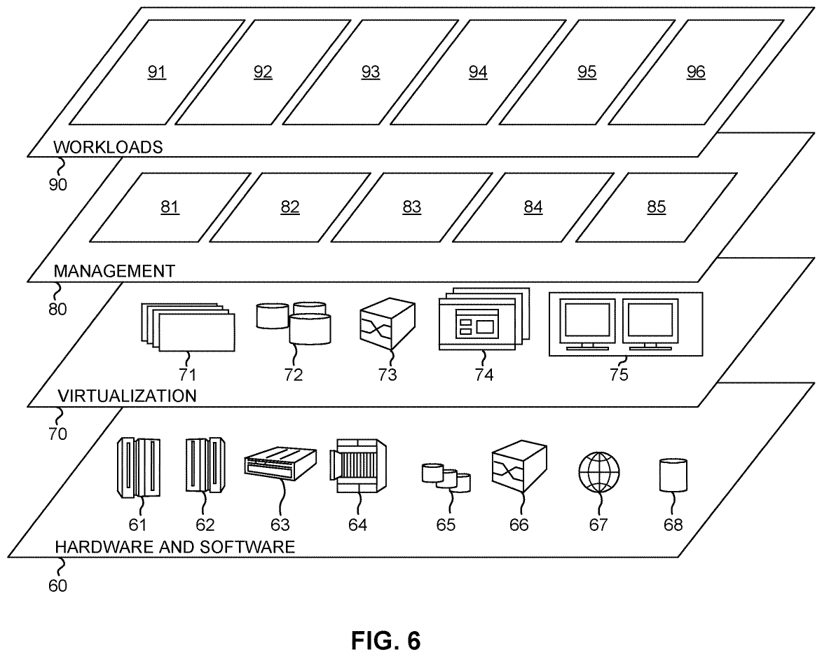

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and document veracity analyzing 96. Document veracity analyzing 96 can be a workload or function such as that described in FIGS. 1 and 2 above. In other embodiments, only a portion of the processing of document veracity analyzing may be cloud based, such as a natural language processing system as depicted in FIG. 3.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But, the various embodiments can be practiced without these specific details. In other instances, well-known circuits, structures, and techniques have not been shown in detail in order not to obscure embodiments.

What is claimed is:

1. A computer-implemented method for machine learning based document analysis using categorization, the method comprising:
receiving a document;
classifying the document;
identifying, using results of the classifying, a plurality of techniques for testing veracity of documents;
determining one or more of the plurality of techniques to use for testing the document;
performing testing of the document using the determined one or more of the plurality of techniques; and
outputting results of the testing to a user.

2. The method of claim 1, further comprising:
receiving feedback from the user; and
updating, based on the feedback, one or more aspects of methodology used in determining the one or more of the plurality of techniques to use for testing the document and performing testing of the document using the determined techniques.

3. The method of claim 1, wherein determining the one or more of the plurality of techniques to use for testing the document comprises:
identifying reliability scores for each of the plurality of techniques.

4. The method of claim 3, wherein the identified reliability scores for each of the plurality of techniques include reliability scores for classifications of documents using the plurality of techniques; and further comprising:
calculating a combined reliability score for each of the plurality of techniques.

5. The method of claim 4, further comprising:
comparing a highest combined reliability score of the combined reliability scores for each of the plurality of techniques with one or more threshold values.

6. The method of claim 5, further comprising:
determining, based on the comparing of the highest combined reliability score with one or more threshold values, a number of techniques to be used.

7. The method of claim 1, wherein determining one or more of the plurality of techniques to use for testing the document comprises determining a number of techniques based on one or more threshold values.

8. A system for machine learning based document analysis using categorization, the system comprising:
one or more processors; and
a memory communicatively coupled to the one or more processors,
wherein the memory comprises instructions which, when executed by the one or more processors, cause the one or more processors to perform a method comprising:
receiving a document;
classifying the document;
identifying, using results of the classifying, a plurality of techniques for testing veracity of documents;
determining one or more of the plurality of techniques to use for testing the document;
performing testing of the document using the determined one or more of the plurality of techniques; and
outputting results of the testing to a user.

9. The system of claim 8, further comprising:
receiving feedback from the user; and
updating, based on the feedback, one or more aspects of methodology used in determining the one or more of the plurality of techniques to use for testing the document and performing testing of the document using the determined techniques.

10. The system of claim 8, wherein determining the one or more of the plurality of techniques to use for testing the document comprises:
identifying reliability scores for each of the plurality of techniques.

11. The system of claim 10, wherein the identified reliability scores for each of the plurality of techniques include reliability scores for classifications of documents using the plurality of techniques; and further comprising:
calculating a combined reliability score for each of the plurality of techniques.

12. The system of claim 11, further comprising:
comparing a highest combined reliability score of the combined reliability scores for each of the plurality of techniques with one or more threshold values.

13. The system of claim 12, further comprising:
determining, based on the comparing of the highest combined reliability score with one or more threshold values, a number of techniques to be used.

14. The system of claim 8, wherein determining one or more of the plurality of techniques to use for testing the document comprises determining a number of techniques based on one or more threshold values.

15. A computer program product for machine learning based document analysis using categorization, the computer program product comprising a computer readable storage medium having program instructions embodied therewith, the program instructions executable by a computer to perform a method comprising:
receiving a document;
classifying the document;
identifying, using results of the classifying, a plurality of techniques for testing veracity of documents;
determining one or more of the plurality of techniques to use for testing the document;
performing testing of the document using the determined one or more of the plurality of techniques; and
outputting results of the testing to a user.

16. The computer program product of claim 15, further comprising:
receiving feedback from the user; and
updating, based on the feedback, one or more aspects of methodology used in determining the one or more of the plurality of techniques to use for testing the document and performing testing of the document using the determined techniques.

17. The computer program product of claim 15, wherein determining the one or more of the plurality of techniques to use for testing the document comprises:
identifying reliability scores for each of the plurality of techniques.

18. The computer program product of claim 17, wherein the identified reliability scores for each of the plurality of techniques include reliability scores for classifications of documents using the plurality of techniques; and further comprising:
calculating a combined reliability score for each of the plurality of techniques.

19. The computer program product of claim 18, further comprising:
comparing a highest combined reliability score of the combined reliability scores for each of the plurality of techniques with one or more threshold values.

20. The computer program product of claim 19, further comprising:
determining, based on the comparing of the highest combined reliability score with one or more threshold values, a number of techniques to be used.
